(19) United States
(12) Patent Application Publication
(10) Pub. No.: US 2019/0026765 A1
(43) Pub. Date: Jan. 24, 2019

(54) EVALUATING SOCIAL REFERRALS TO A THIRD PARTY SYSTEM

(71) Applicant: Facebook, Inc., Menlo Park, CA (US)

(72) Inventors: Tesia Sommer, San Francisco, CA (US); Haowei Lu, Seattle, WA (US)

(21) Appl. No.: 15/657,318

(22) Filed: Jul. 24, 2017

(51) Int. Cl. G06Q 30/02

(52) U.S. Cl. CPC G06Q 30/0214; G06Q 30/0247; G06Q 30/0277

(57) ABSTRACT

An online system identifies users of the online system for a subject user to refer to a third party system. The online system receives a sponsoring request to present referral opportunities to users of the third party system. Based on the sponsoring request, the online system identifies subject users of the online system that use the third party system. Then, referral recommendations are identified for the subject users, and a referral score for each subject user is determined based on the identified referral recommendations for that user. Referral scores are used to select which subject users to present with a referral opportunity. The referral opportunity is presented to the selected subject users, the online system receives a selection of referral recommendations from the subject users and sends a referral from the subject users to each of the selected referral recommendations.

### BACKGROUND

This disclosure relates generally to enabling users of an online system to refer other users of the online system to a third party system.

In general, potential customers that are referred to a product or service by an existing customer are often the most profitable customers. Furthermore, referred customers are more likely to refer additional customers in turn.

Many referrals are received from individuals with whom a potential customer is not personally familiar. Such referrals are generally not as effective because they are less trusted than referrals received from individuals with whom the referred customer is familiar. Furthermore, fraudulent referrals in which fabricated identities are used to refer potential customers can create mistrust of a product. However, even if a referral is performed by an individual with whom the potential customer is familiar, such referrals are commonly accomplished through word of mouth, and as a result travel slowly and inefficiently. Thus a product is needed to streamline the referral process for closely linked, trusted individuals with familiar and verified identities.

### SUMMARY

This disclosure describes a method for one or more subject users of an online system to refer one or more other users of the online system to a third party system. A subject user who interacts with the third party may receive a referral opportunity suggesting one or more users to whom the subject user may send a referral. The referral opportunity thus provides “referral recommendations” to the subject user. A referral recommendation is a user of the online system that is suggested to the subject user by the online system, to whom the subject user may send a referral. The online system identifies subject users for presenting with a referral opportunity and identifies which users are eligible to be referral recommendations for the subject users. The subject users and referral recommendations may be evaluated to score presenting a referral opportunity on the online system. The scores may be used to determine which (and how many) subject users to send the referral opportunity to and to evaluate the referral opportunity against other content presented by the online system, such as other referral opportunities, other engagement content with the online system, or other sponsored content.

First, the online system receives, from the third party system, a sponsoring request to present referral opportunities to users of the third party system. The sponsoring request includes one or more content items which the third party system wishes to present, via a referral from a subject user, to one or more users of the online system to encourage the user to use the third party system. The sponsoring request may thus provide the content that a referring user (subject user) sends to a user. In some embodiments, the sponsoring request also includes content provided in the referral opportunity that is sent to the subject user.

In some embodiments, a sponsoring request may also include a bid amount and/or targeting criteria for selecting and evaluating which users of the third party system to send the referral opportunity. A bid amount is used to determine an expected value, such as monetary compensation, provided by the third party system to the online system if a specified condition is satisfied when content in the sponsoring request is presented to a user. For example, the bid amount may be contingent on a subject user electing to send a referral to one or more referral recommendations, or may be contingent on the referral recommendations that receive the referral subsequently interacting with the referral or performing an action on the third party system. The likelihood of these actions may be used to determine a value for presenting the referral opportunity to a subject user.

Targeting criteria specifies one or more characteristics of users eligible to be presented with the referral opportunity and/or the referral. Targeting criteria may be applied to subject users that receive the referral opportunity or to users that may receive referrals from the subject users (e.g. referral recommendations).

The online system identifies one or more subject users of the online system that use the third party system. Targeting criteria included in the sponsoring request may be used to identify eligible subject users.

The online system identifies users eligible to receive a referral from each subject user of the one or more subject users. These identified users are known as referral recommendations for the subject users. Each subject user is then presented with a referral opportunity that includes the identified referral recommendations. Targeting criteria may be used to select eligible referral recommendations for a subject user. In some embodiments, targeting criteria may specify that users eligible to receive a referral are not already associated with the third party system. In addition to specifying eligible or ineligible, the targeting criteria may also be used to score the referral recommendations. These scores and rankings may subsequently be used to select referral recommendations for a subject user.

The online system determines a referral score for each subject user of the one or more subject users. A referral score is a quantitative scoring of the degree to which the subject user may provide a successful referral to the third party system of a user having the specified targeting criteria. In embodiments in which referral recommendations are scored and ranked, the referral recommendation scores may also be used in determining the referral score for the subject user.

Based on the referral score determined for each subject user, the online system presents a referral opportunity to one or more of the subject users. In other words, the online system uses the referral scores determined for the subject users to select which subject users to present with a referral opportunity. In some embodiments, the bid amount specified by the sponsoring request is used with the referral score to evaluate presentation of the referral opportunity to a subject user.

For example, for a given subject user, many types of content be evaluated for presentation to the subject user. When a user accesses the online system, the online system may identify an opportunity to present content to the user. The user may be identified based on the targeting criteria of the sponsoring request as an eligible subject user, for example because the user uses the third party system and has characteristics matching the targeting criteria. A particular referral opportunity may be evaluated with respect to that subject user and be selected for that subject user based on the other content items competing for placement to the subject user. The other content may likewise have targeting criteria or other means for evaluating placement to the user. When presented to the subject user, the referral opportunity includes the referral recommendations for the subject user.

The online system receives a selection of referral recommendations from the subject user presented with the referral opportunity. In other words, the subject user can accept the recommendations from the online system and refer the recommended users, or the subject user can reject the recommendations and decide not to refer the recommended users.

If the subject user accepts one or more referral recommendations, the online system sends a referral from the subject user to each of the selected referral recommendations. The referral may include the content item provided by the sponsoring request.

Finally, the online system receives an indication that the referral recommendation interacted with the referral sent from each subject user of the one or more subject users. Tracking actions of the referral recommendations allows the online system to inform the third party system regarding the results of a sponsoring request and to gather data for use in future iterations of referral opportunities.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for referring users of an online system to a third party system, in accordance with an embodiment

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

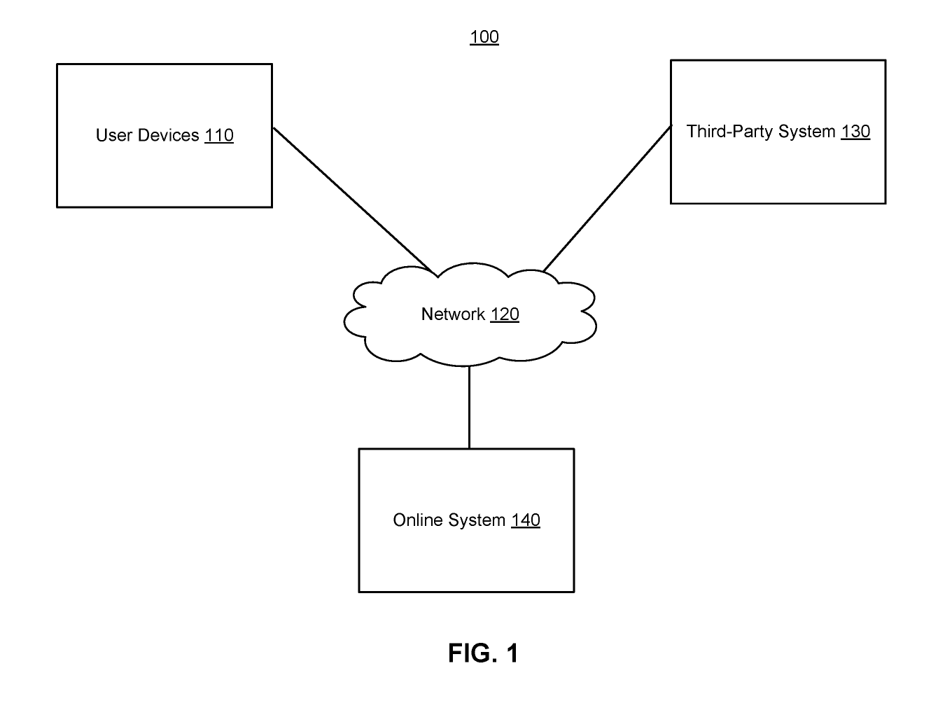

FIG. 1 is a block diagram of a system environment 100 for an online system 140. The system environment 100 shown by FIG. 1 comprises one or more user devices 110, a network 120, one or more third-party systems 130, and the online system 140. In alternative configurations, different and/or additional components may be included in the system environment 100. For example, the online system 140 is a social networking system, a content sharing network, or another system providing content to users.

The user devices 110 may request and receive content from the online system 140, as well as interact with the third party systems 130. The online system 140 receives sponsoring requests from the third party system to identify users of the online system 140 to present with referral opportunities. When a subject user refers another user of the online system 140, the other user may receive the referral on the user's client device 110 interact with the third party system 130 via the referral. The online system 140 may thus identify which users of the online system 140 to present with referral opportunities, who to recommend for referral in the referral opportunity, and evaluate the presentation of referral opportunities for the third party system. Because users may be active on the online system 140 and the online system 140 may use interactions and relationships between users of the online system 140 in providing recommendations, the online system 140 may improve referrals to the third party system and decrease the likelihood of fraudulent referrals to the third party system 130.

The user devices 110 are one or more computing devices capable of receiving user input as well as transmitting and/or receiving data via the network 120. In one embodiment, a user device 110 is a conventional computer system, such as a desktop or a laptop computer. Alternatively, a user device 110 may be a device having computer functionality, such as a personal digital assistant (PDA), a mobile telephone, a smartphone, or another suitable device. A user device 110 is configured to communicate via the network 120. In one embodiment, a user device 110 executes an application allowing a user of the user device 110 to interact with the online system 140. For example, a user device 110 executes a browser application to enable interaction between the user device 110 and the online system 140 via the network 120. In another embodiment, a user device 110 interacts with the online system 140 through an application programming interface (API) running on a native operating system of the user device 110, such as IOS® or ANDROID™.

The user devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

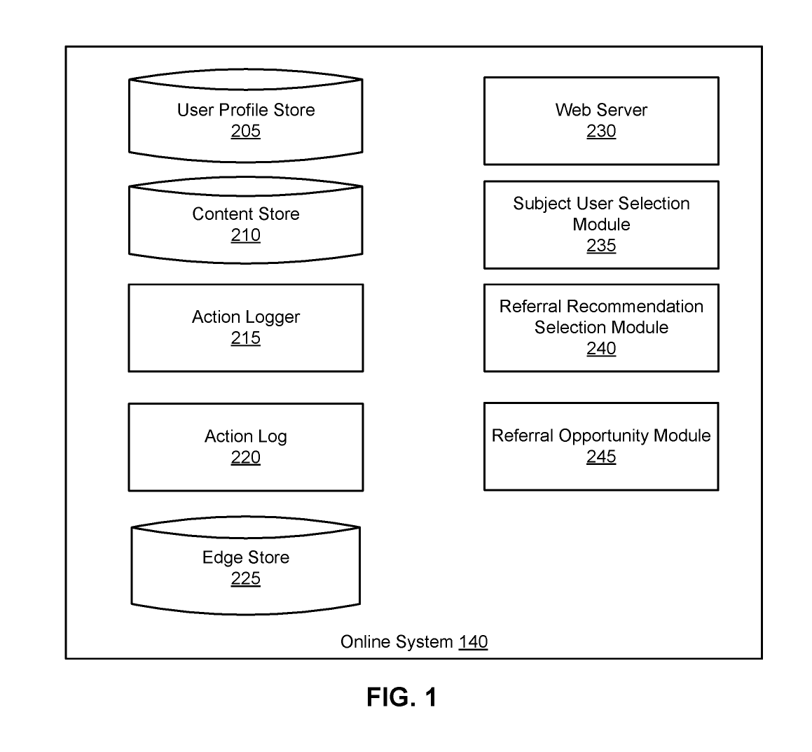

One or more third party systems 130 may be coupled to the network 120 for communicating with the online system 140, which is further described below in conjunction with FIG. 2. In one embodiment, a third party system 130 is an application provider communicating information describing applications for execution by a user device 110 or communicating data to user devices 110 for use by an application executing on the user device. In other embodiments, a third party system 130 provides content or other information for presentation via a user device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a web server 230, a subject user selection module 235, a referral recommendation selection module 240, and a referral opportunity module 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed.

Some content items include sponsored content for a referral. This sponsored content may include both content for a referral opportunity to present to a subject user, and content for the referral itself. The referral opportunity is a content item which provides an option for the subject user to provide a referral to additional users of the online system 140 to a third party system 130 used by the subject user viewing the referral opportunity. The referral is a content item that is sent from the subject user to the additional users of the online system 140. For example, the third party system 130 may provide an application for ordering delivered food, and the referral opportunity may suggest, to a subject user of the online system 140 who orders food through the third party system 130, connections in the online system 140 of the subject user to suggest for also using the food delivery application of the third party system 130. The connections suggested by the online system 140 to the subject user within the referral opportunity are known as referral recommendations. Specifically, referral recommendations are recommendations provided to the referring user by the online system 140 of the additional users that may be referred by the referring user. Such embodiments are discussed in greater detail below.

The bid amount is included in a content item by a third party system 130 and is used to determine an expected value, such as monetary compensation, provided by the third party system 130 to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a third party system 130 that provided the content item to the online system 140 if content in the content item is displayed to a subject user of the online system 140. As another example, when the content item is a referral opportunity, the bid amount included in the content item specifies a monetary amount that the online system 140 receives from a third party system 130 that provided the content item to the online system 140 if content in the content item is displayed to a subject user of the online system 140 and is subsequently referred by the subject user to one or more additional users of the online system 140. In a further embodiment, the bid amount specifies a monetary amount that the online system 140 receives from a third party system 130 that provided the content item to the online system 140 if content in the content item is interacted with by the one or more additional users that were referred by the subject user. In some embodiments, the expected value to the online system 140 of presenting the referral opportunity may be determined by multiplying the bid amount by a probability of the referral opportunity being accessed by the subject user, as well as a probability of users that are referred by the subject user accessing the referral.

In various embodiments, a content item includes various components capable of being identified and retrieved by the online system 140. Example components of a content item include: a title, text data, image data, audio data, video data, a landing page, a user associated with the content item, or any other suitable information. The online system 140 may retrieve one or more specific components of a content item for presentation in some embodiments. For example, the online system 140 may identify a title and an image from a content item and provide the title and the image for presentation rather than the content item in its entirety.

Various content items may include an objective identifying an interaction that a third party system 130 associated with a content item desires users of the online system 140 to perform when presented with content included in the content item. Example objectives include: installing an application associated with a content item, indicating a preference for a content item, sharing a content item with other users, referring other users to the content item, interacting with an object associated with a content item, or performing any other suitable interaction. As content from a content item is presented to online system users, the online system 140 logs interactions between users presented with the content item or with objects associated with the content item. In embodiments in which a content item includes a referral opportunity, the online system 140 logs interactions between a subject user presented with the content item and users referred to the content item by the subject user, as well as interactions between the referred users and objects associated with the content item. Additionally, the online system 140 may receive compensation from a third party system 130 associated with a content item as online system users perform interactions with the content item that satisfy the objective included in the content item.

Additionally, a content item may include one or more targeting criteria specified by the third party system 130 that provided the content item to the online system 140. Targeting criteria included in a content item request specify one or more characteristics of users eligible to be presented with the content item. For example, when the content item is a referral opportunity, the content item may specify targeting criteria for subject users who may receive the referral opportunity. In a further embodiment, targeting criteria may specify characteristics for users who may be suggested as referral recommendations to the subject user receiving the referral opportunity, and may specify the content to be used in a referral when a subject user elects to send the referral to one or more of the referral recommendations. For example, targeting criteria are used to identify users having user profile information, edges, or actions satisfying at least one of the targeting criteria. Hence, targeting criteria allow for identification of users having specific characteristics, simplifying subsequent distribution and referrals of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

In various embodiments, the content store 210 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 140 provides the online system 140 with various campaigns each including content items having different characteristics (e.g., associated with different content, including different types of content for presentation), and the campaigns are stored in the content store.

The action logger 215 receives communications about user actions internal to and/or external to the online system 140, populating the action log 220 with information about user actions. Examples of actions include adding a connection to another user, sending a message to another user, referring another user to a content item, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a user device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a user device 110 may be communicated to the action logger 215 by the application for recordation and association with the user in the action log 220.

In one embodiment, a third party system 130 uses a tracking pixel or piece of HTML code placed by the third party system 130 on third-party websites to monitor users visiting the websites that have not opted out of tracking. A tracking pixel might be included on various pages, including on a product page describing a product, on a shopping cart page that the user visits upon putting something into a shopping cart, on a checkout page that the user visits to checkout and purchase a product, etc. For example, a tracking pixel results in a transparent lx1 image, an iframe, or other suitable object being created for third party pages. When a user's browser loads a page having the tracking pixel, the tracking pixel results in the user's browser attempting to retrieve the content for that pixel, and the browser contacts the online system 140 to retrieve the content. The request sent to the online system 140, however, actually includes various data about the user's actions taken on the third party website. The third party system 130 can control what data is sent to the online system 140. For example, the third party system 130 may include information about the page the user is loading (e.g., is it a product page, a shopping cart page, a checkout page, etc.), about information on the page or about a product on the page of interest to the user (e.g., the SKU number of the product, the color, the size, the style, the current price, any discounts offered, the number of products requested, etc.), about the user (e.g., the third party's user identifier (UID) for the user, contact information for the user, etc.), and other data. In some embodiments, a cookie set by the online system 140 can also be retrieved by the online system 140, which can include various data about the user, such as the online systems' UID for the user, information about the user device 110 and the browser, such as the Internet Protocol (IP) address of the user device 110, among other data. Tracking can also be performed on mobile applications of content providers by using a software development kit (SDK) of the online system 140 or via an application programming interface (API) of the online system 140 to track events (e.g., purchases) that occur by users on the content provider's app that are reported to the online system 140.

The online system 140 can then store this data in the action log 220 and use this data received about the user to serve better content to the user in the future (e.g., since the online system 140 has further data about products purchased or browsed that might be of interest), and can also use this in retargeting of that product to the user (e.g., where the user went to the product page on the third party site by clicking on an of the third party system 130 presented to the user in the online system 140). The online system 140 can also use this data in conversion tracking and reporting results of advertising campaigns to the third party system 130. For example, if the third party system 130 has spent money at the online system 140 to have the online system 140 serve ads for its products, and a particular user views an ad on the online system and then purchases the product advertised (possibly at some point later, and possibly on a different device), the online system 140 can link the purchase/conversion to the ad originally shown on the online system 140. Thus, the online system 140 can include this data in its reporting to the third party system 130 of how many conversions the ad campaign received.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The web server 230 links the online system 140 via the network 120 to the one or more user devices 110, as well as to the one or more third party systems 130. The web server 230 serves web pages, as well as other content, such as JAVA®, FLASH®, XML and so forth. The web server 230 may receive and route messages between the online system 140 and the user device 110, for example, instant messages, queued messages (e.g., email), text messages, short message service (SMS) messages, or messages sent using any other suitable messaging technique. A user may send a request to the web server 230 to upload information (e.g., images or videos) that are stored in the content store 210. Additionally, the web server 230 may provide application programming interface (API) functionality to send data directly to native user device operating systems, such as IOS®, ANDROID™, or BlackberryOS.

The subject user selection module 235 selects users of the online system 140 to present with content items provided by a third party system 130. These selected users are known as “subject users” for that content item. When a user accesses the online system 140, the various content items for which the user is a subject user may be considered and evaluated for selection of content for the user.

One type of content item provided by a third party system 130 for presentation to subject users of the online system 140 is a referral opportunity. As mentioned above, a referral opportunity is an opportunity for a subject user to refer users of the online system 140 to the third party system 130. In some embodiments, a referral opportunity includes a set of referral recommendations. Each referral recommendation in the referral opportunity is a user that the online system 140 recommends to the subject user for referral to the third party 130.

In various embodiments, the subject user selection module 235 may use targeting criteria to select users of the online system 140 as subject users for the referral opportunity. As noted above, subject user targeting criteria specifies one or more characteristics of users eligible to be presented with the content item. Targeting criteria for subject users may be specified by the third party system 130, by the online system 140, or by both the third party system 130 and the online system 140. The subject user selection module 235 accesses one or more of the user profile store 205, the content store 210, the action log 220, and the edge store 225 to retrieve information about the subject users and determine whether or not the subject users satisfy specified targeting criteria. Using this information, subject users are selected by the subject user selection module 235.

There are multiple embodiments of targeting criteria that may be used to identify users that are eligible to receive a referral opportunity. In one embodiment, targeting criteria may specify user characteristics. In addition, the targeting criteria may specify actions performed by users on the online system or with respect to a third party system 130. For example, targeting criteria may require that subject users have previously interacted with the referral opportunity or with the third party system 130 that is associated with the referral opportunity. As another example, if the content item included within a referral opportunity is a link to download an application, subject user targeting criteria may specify that only users that have previously downloaded the application are eligible for selection as a subject user.

In another embodiment, targeting criteria may be related to referral recommendations for a subject user. To apply these targeting criteria, referral recommendations may be identified for the subject user, and the identified referral recommendations may be used to determine whether the subject user is eligible to receive the referral opportunity. For example, targeting criteria may specify that subject users possess at least a threshold probability that the subject user will select a certain number of the referral recommendations included within the referral opportunity. Alternatively, targeting criteria may specify that subject users possess at least a threshold probability of referring alternative users outside of the referral recommendations. Such probabilities may be calculated using historical information about the subject user's actions and characteristics that are stored in the user profile store 205, the action log 220, or the edge store 225. Specifically, a predictive computer model may be trained using this historical information stored by the online system 140 to estimate such probabilities. For instance, the predictive computer model may use data about a subject user's previous interactions with referral opportunities. As another example, targeting criteria used to identify subject users may specify that subject users have a threshold number of referral recommendations that satisfy referral recommendation targeting criteria. Such additional targeting criteria for referral recommendations is discussed in greater detail below with regard to the referral recommendation selection module 240.

In some embodiments, a user that is eligible to receive a referral opportunity is a user of the online system 140 that is associated with at least a threshold number or proportion of targeting criteria associated with the referral opportunity. Alternatively, the subject user selection module 240 may assign referral scores to subject users based on fulfillment of targeting criteria and use these referral scores to select subject users. Quantitatively scoring subject users provides the subject user selection module 240 with a definitive method for selecting subject users. In one embodiment, only a specified number of subject users with the highest referral scores are presented with referral opportunities.

Scoring of subject users may be determined based on a variety of factors, including the subject user targeting criteria described above. For example, subject user scoring may be based on the likelihood that the subject user will refer the referral recommendations included within the referral opportunity. In some embodiments, scores determined for referral recommendations associated with a subject user may also be factored into the subject user's referral score. Such embodiments are discussed in greater detail below with regard to the referral recommendation selection module 240.

In some embodiments, there may be a risk of selecting fraudulent users as subject users. To avoid selecting fraudulent users of the online system 140 as subject users, in some embodiments, subject users must adhere to specified usage criteria for the online system 140. One example of usage criteria is a threshold duration of membership on the online system 140. Another example of usage criteria is a threshold level of interaction on the online system 140. For example, a user that joined the online system within the last 24 hours may not be eligible for selection as a subject user. By establishing such usage criteria, the online system 140 avoids presenting referral opportunities to subject users or users who may not properly represent new opportunities for users of the third party system.

The referral recommendation selection module 240 selects one or more referral recommendations for inclusion within a referral opportunity that is presented to a subject user. The referral recommendations are users of the online system 140 that are suggested by the online system 140 to the subject user, to receive a referral from the subject user. Referral recommendations are retrieved from the user profile store 205 or from another source by the referral recommendation selection module 240.

Similar to the subject user targeting criteria described above and used by the subject user selection module 235 in selecting subject users for presentation with referral opportunities, the referral recommendation selection module 240 may also use referral recommendation targeting criteria to select users of the online system 140 as referral recommendations. Targeting criteria for referral recommendations may be specified by the third party system 130, by the online system 140, or by both the third party system 130 and the online system 140. The referral recommendation selection module 240 accesses one or more of the user profile store 205, the content store 210, the action log 220, and the edge store 225 to retrieve information about the users and determine whether or not the users satisfy specified targeting criteria specified for referral recommendations. Using this information, referral recommendations are selected by the referral recommendation selection module 240.

Various targeting criteria may be used in the identification of referral recommendations by the referral recommendation selection module 240. In one embodiment, targeting criteria for referral recommendations may specify that referral recommendations possess at least a threshold conversion probability that indicates the likelihood that the referred user will interact with the content item referred by the subject user. This probability may be calculated using information about users' actions and characteristics stored in the user profile store 205, the action log 220, or the edge store 225. Specifically, a predictive computer model may be trained using this historical information stored by the online system 140 to estimate such probabilities. For instance, the predictive computer model may use data about a user's previous interactions with referrals. In a further embodiment, targeting criteria for referral recommendations may specify that referral recommendations possess at least a threshold second-hand referral score that indicates the likelihood that the referral recommendations will in turn refer additional users in the future. As another example, referral recommendation targeting criteria may require that a referral recommendation has not interacted with the content item or the third party system 130 associated with the referral. For example, if the content item included within a referral is a link to download an application, referral recommendation targeting criteria may specify that users that have already downloaded the application are not eligible to be a referral recommendation. Alternatively, referral recommendation targeting criteria may specify that a referral recommendation must have had past interaction with the content item or the third party system 130 associated with the referral. In a further embodiment, referral recommendation targeting criteria may simply limit the number of referral recommendations that have interacted with the content item or the third party system 130. As another example, targeting criteria for a referral recommendation may specify that a subject user has at least a threshold affinity to the referral recommendation. For example, users who are not connected to the subject user with less than a threshold affinity are not selected as referral recommendations. As noted above, affinities, or affinity scores, may be computed by the online system 140 over time to approximate a user's interest in another user in the online system 140 based on the actions performed by the user. Other embodiments of referral recommendation targeting criteria not explicitly mentioned here are also possible.

In some embodiments, a user that is eligible to be a referral recommendation in a referral opportunity is a user of the online system 140 that fulfills at least a threshold number or proportion of targeting criteria associated with the referral opportunity. Alternatively, the referral recommendation selection module 240 may score and rank users based on fulfillment of targeting criteria and use these scores and rankings to select referral recommendations. Quantitatively scoring users provides the referral recommendation selection module 240 with a definitive method for selecting referral recommendations for subject users.

Scoring of users that are candidate referral recommendations may be determined based on a variety of factors, including the referral recommendation targeting criteria described above. For example, referral recommendation scoring may be based on the likelihood that a user will convert the content item associated with the referral. In further embodiments, the referral recommendation score may be based on prior interaction with referrals by the user, other users to whom the user is connected, or other criteria. As another example, if a user has already engaged with the content item presented in the referral opportunity, that user may be down-ranked as a referral recommendation.

Using the referral recommendations scores, the referral recommendation selection module 240 may also rank referral recommendations. This ranking may be used to determine the order in which selected referral recommendations are presented to the subject user within the referral opportunity. For example, in one embodiment, the referral recommendation selection module 240 orders referral recommendations within the referral opportunity based on likelihoods of the referral recommendations interacting with various content items associated with the referral opportunity. In another embodiment, the referral recommendation selection module 240 orders referral recommendations within the referral opportunity based on the affinity of the subject user to the referral recommendations. In one embodiment, a ranked list of referral recommendations may be presented to the subject user in some embodiments. In other embodiments, only a specified number of referral recommendations with the highest rankings are presented to the subject user with the referral opportunity. Additional embodiments for ordering the referral recommendations that are not explicitly included herein are also possible.

In some embodiments, scores for each of the selected referral recommendations for a given subject user are aggregated and used by the subject user selection module 235 in generating referral scores for the subject users. As described above with regard to the subject user selection module 235, these subject user referral scores are subsequently used in selecting subject users for presentation with the referral opportunity.

In some embodiments, there may be a risk of selecting fraudulent users as referral recommendations for subject users. To avoid selecting fraudulent users of the online system 140 as referral recommendations, in some embodiments, referral recommendations must adhere to specified usage criteria for the online system 140. One example of usage criteria is a threshold duration of membership on the online system 140. Another example of usage criteria is a threshold level of interaction on the online system 140. For example, a user that joined the online system within the last 24 hours may not be eligible for selection as a referral recommendation. By establishing such usage criteria, the online system 140 avoids recommending fraudulent users to subject users presented with referral opportunities.

The referral opportunity module 245 provides referral opportunities to subject users selected by the subject user selection module 235. As described in detail above, in some embodiments the referral opportunity module 245 includes referral recommendations from the referral recommendation selection module 240 in the referral opportunities provided to the subject users.

In some embodiments, referral opportunities are provided to the subject user in a feed provided to the subject user. In alternative embodiments referral opportunities are provided to the subject user within a message. Referral opportunities may also be provided in alternative mediums. When provided with referral recommendations, a subject user can either choose to accept or reject a referral recommendation. In other words, a subject user can take the recommendation from the online system 140 and refer the recommended user, or the subject user can reject the recommendation and decide not to refer the recommended user.

In some embodiments, such as those described above with regard to the subject user recommendation module 235, subject user referral scores are used in determining which subject users receive referral opportunities. For example, only subject users that possess a referral score above a certain threshold may be presented with referral opportunities.

In alternative embodiments, bid amounts associated with referral opportunities are used by the referral opportunity module 245 when selecting referral opportunities for presentation to a subject user. As described above with regard to the content store 210, in some embodiments, a sponsoring request provided to the online system 140 by a third party system 130 may include a bid amount. The bid amount is used to determine an expected value, such as monetary compensation, provided by the third party system 130 to the online system 140 if any suitable condition is satisfied when content in the referral opportunity is presented to a subject user. In embodiments in which sponsoring requests include bid amounts, the referral opportunity module 245 may use these bid amounts in determining which referral opportunities to present to which subject users.

For example, in certain embodiments, the referral opportunity module 245 determines expected values associated with presentation of the referral opportunity to various subject users based on the bid amount and selects subject users to receive referral opportunities associated with a maximum expected value or associated with at least a threshold expected value. An expected value associated with a referral opportunity represents an expected amount of compensation to the online system 140 for presenting the referral opportunity to the subject user. For example, the expected value associated with a referral opportunity is a product of the sponsoring request's bid amount and a subject user's referral score. The referral opportunity module 245 may rank referral opportunities based on their expected value and select referral opportunities having at least a threshold position in the ranking for presentation to the subject user. In some embodiments, the referral opportunity module 245 ranks both referral opportunities not associated with bid amounts and referral opportunities associated with bid amounts in a unified ranking based on bid amounts and measures of relevance associated with referral recommendations. Based on the unified ranking, the referral opportunity module 245 selects referral opportunities for presentation to the subject user. Selecting content items (such as referral opportunities) through a unified ranking is further described in U.S. patent application Ser. No. 13/549,080, filed on Jul. 13, 2012, which is hereby incorporated by reference in its entirety.

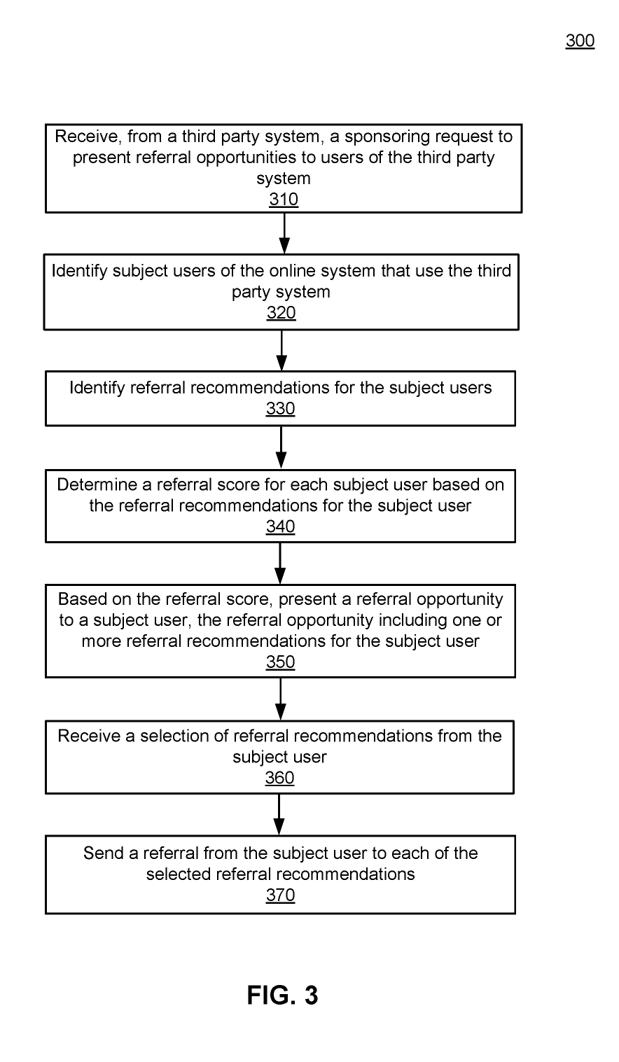

FIG. 3 is a flow chart of a method 300 for referring users of an online system 140 to a third party system 130, in accordance with an embodiment. In other embodiments, the method may include different and/or additional steps than those shown in FIG. 3. Additionally, steps of the method may be performed in different orders than the order described in conjunction with FIG. 3 in various embodiments.

The online system 140 receives 310, from a third party system 130, a sponsoring request to present referral opportunities to users of the third party system 130. A sponsoring request includes one or more content items which the third party system 130 wishes to present, via a referral, to one or more users of the online system 140. The one or more content items included by the third party system 130 in the sponsoring request may include text, image, audio, video, or any other suitable data for presentation to a user. In various embodiments, the content also specifies a page of content. For example, a content item includes a landing page specifying a network address of a page of content to which a user is directed when the content item is accessed. In further embodiments, a content item includes a deep-link that specifies a network address of a page of content and also includes pre-populated information specific to the user that accesses the content item. Such pre-populated information might be demographic or social information about the user stored or learned by the online system 140. In other embodiments, pre-populated information may be a coupon or promotional code used to access a particular feature of the content page.

In some embodiments, a sponsoring request may also include a bid amount and/or targeting criteria. As described above with regard to FIG. 2, a bid amount is included in the sponsoring request by the third party system 130 and is used to determine an expected value, such as monetary compensation, provided by the third party system 130 to the online system 140 if content in the sponsoring request is presented to a user, if the content in the sponsoring request receives a user interaction when presented, or if any suitable condition is satisfied when content in the sponsoring request is presented to a user. Targeting criteria specifies one or more characteristics of users eligible to be presented with the content item included within the sponsoring request. Targeting criteria may be applied to subject users that receive the referral opportunity, and/or referral recommendations that receive referrals from the subject users. Examples of targeting criteria are discussed in detail with regard to FIG. 2 above.

The online system 140 identifies 320 subject users of the online system 140 that use the third party system 130. Subject users are users of the online system 140 that are selected to receive referral opportunities provided by the third party system 130. As described above, in various embodiments the targeting criteria specified in step 310 may be used to identify eligible subject users. Targeting criteria used in identifying subject users may be related solely to user characteristics. For example, to be eligible for selection as a subject user, users of the online system 140 may be required to be users of the third party system 130. In another embodiment, targeting criteria used in identifying subject users may be related to referral recommendations associated with a subject user.

The online system 140 identifies 330 referral recommendations for the subject users. Referral recommendations are one or more users of the online system 140. In some embodiments, referral recommendations are connected to the subject users by an edge stored within the edge store 225 of the online system 140.

Targeting criteria may also be used to select referral recommendations for a subject user. In some embodiments, a user that is eligible to be a referral recommendation is a user of the online system 140 that fulfills at least a threshold number or proportion of targeting criteria associated with the referral opportunity. Alternatively, referral recommendations may be scored and ranked based on fulfillment of targeting criteria. These scores and rankings may subsequently be used to select referral recommendations.

The online system 140 determines 340 a referral score for each subject user based on the referral recommendations identified for the subject user in step 330. A referral score for a subject user is a quantitative scoring of the degree to which the subject user fulfills targeting criteria. As mentioned above, in various embodiments, targeting criteria for a subject user may be related to referral recommendations associated with the subject user. For example, targeting criteria may specify a required threshold of affinity of the subject user to a referral recommendation. As another example, targeting criteria may specify a required threshold probability that a referral recommendation of a subject user interacts with the referral provided to the referral recommendation by the subject user. Subject user fulfillment of such referral recommendation-related targeting criteria may be used to determine 340 a referral score for the subject user.

As described above with regard to step 330, in some embodiments, referral recommendations themselves may be scored and ranked based on fulfillment of targeting criteria. In one embodiment, the scores determined for the referral recommendations of a subject user may be aggregated and used as the referral score for the subject user. In alternative embodiments, the subject user's referral score may be based in part on the scores determined for the referral recommendations of the subject user. In other embodiments, the subject user's referral score may not be dependent upon scores associated with the subject user's referral recommendations.

Based on the referral score generated for each subject user in step 340, the online system 140 presents 350 a referral opportunity to a subject user, the referral opportunity including one or more referral recommendations for the subject user. In other words, the online system 140 uses the referral scores determined for the subject users to select which subject users to present with a referral opportunity. In some embodiments, only the subject user with the highest referral score is presented with a referral opportunity. In other embodiments, subject users with a threshold referral score are presented with referral opportunities. In alternative embodiments a specified number of subject users with the highest referral scores are presented with referral opportunities. In even further embodiments, bid amounts associated with the referral opportunities are used in selecting referral opportunities to present to subject users. Such embodiments are described in greater detail with regard to the referral opportunity module 245 of FIG. 2.

In some embodiments, referral opportunities are provided to the subject user in a feed. In alternative embodiments referral opportunities are provided to the subject user within a message. Referral opportunities may also be provided in alternative mediums. In various embodiments, a referral opportunity presented to a subject user includes one or more of the referral recommendations identified for the subject user in step 330.

The online system 140 receives 360 a selection of referral recommendations from the subject user. When provided with referral recommendations within a referral opportunity, a subject user can either choose to accept or reject the referral recommendations. In other words, the subject user can accept the recommendations from the online system 140 and refer the recommended users, or the subject user can reject the recommendations and decide not to refer the recommended users.

If the subject user accepts one or more referral recommendations in step 360, the online system 140 sends 370 a referral from the subject user to each of the referral recommendations selected in step 360. The referral includes the content item provided by the sponsoring request. As with the referral opportunity, referrals sent from the subject user to the referral recommendation may be provided in a feed, within a message, or via any alternative medium.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for one or more subject users of an online system to refer one or more users of the online system to a third party system, the method comprising:
receiving, from the third party system, a sponsoring request to present referral opportunities to users of the third party system;
identifying one or more subject users of the online system that use the third party system;
identifying referral recommendations for each subject user of the one or more subject users, wherein the referral recommendations comprise one or more users of the online system for the subject user to refer to the third party system;
determining a referral score for each subject user of the one or more subject users based on the referral recommendations for the subject user;
based on the referral score for each subject user, presenting a referral opportunity to each subject user of the one or more subject users, the referral opportunity including the referral recommendations for the subject user;
receiving a selection of referral recommendations from each subject user of the one or more subject users; and
sending a referral from each subject user of the one or more subject users to each of the selected referral recommendations.

2. The method of claim 1, wherein the sponsoring request includes targeting criteria used in identifying the one or more subject users.

3. The method of claim 1, wherein the sponsoring request includes targeting criteria used in identifying the referral recommendations.

4. The method of claim 1, wherein a specified proportion of the identified referral recommendations are not users of the third party system.

5. The method of claim 1, wherein determining a referral score for each subject user further comprises:
determining a degree to which the subject user fulfills subject user targeting criteria included in the sponsoring request.

6. The method of claim 5, wherein the subject user targeting criteria comprises a threshold affinity of the subject user to the referral recommendations identified for the subject user.

7. The method of claim 1, wherein determining a referral score for each subject user further comprises:
determining a degree to which the referral recommendations for the subject user fulfill targeting criteria included in the sponsoring request.

8. The method of claim 7, wherein the referral recommendation targeting criteria comprises a threshold probability that the referral recommendations will perform an objective included in the sponsoring request after receiving a referral from the subject user.

9. The method of claim 7, wherein the referral recommendation targeting criteria comprises a threshold affinity of the referral recommendations to the subject user.

10. The method of claim 1, wherein presenting a referral opportunity to each subject user is further based on a bid amount included in the sponsoring request associated with the referral opportunity.

11. A computer program product for one or more subject users of an online system to refer one or more users of the online system to a third party system, the computer program product comprising a computer-readable storage medium containing computer program code for:
receiving, from the third party system, a sponsoring request to present referral opportunities to users of the third party system;
identifying one or more subject users of the online system that use the third party system;
identifying referral recommendations for each subject user of the one or more subject users, wherein the referral recommendations comprise one or more users of the online system;
determining a referral score for each subject user of the one or more subject users based on the referral recommendations for the subject user;
based on the referral score for each subject user, presenting a referral opportunity to each subject user of the one or more subject users, the referral opportunity including the referral recommendations for the subject user;
receiving a selection of referral recommendations from each subject user of the one or more subject users; and
sending a referral from each subject user of the one or more subject users to each of the selected referral recommendations.

12. The computer program product of claim 11, wherein the sponsoring request includes targeting criteria used in identifying the one or more subject users.

13. The computer program product of claim 11, wherein the sponsoring request includes targeting criteria used in identifying the referral recommendations.

14. The computer program product of claim 11, wherein a specified proportion of the identified referral recommendations are not users of the third party system.

15. The computer program product of claim 11, wherein determining a referral score for each subject user further comprises:
determining a degree to which the subject user fulfills subject user targeting criteria included in the sponsoring request.

16. The computer program product of claim 15, wherein the subject user targeting criteria comprises a threshold affinity of the subject user to the referral recommendations identified for the subject user.

17. The computer program product of claim 11, wherein determining a referral score for each subject user further comprises:
determining a degree to which the referral recommendations for the subject user fulfill targeting criteria included in the sponsoring request.

18. The computer program product of claim 17, wherein the referral recommendation targeting criteria comprises a threshold probability that the referral recommendations will perform an objective included in the sponsoring request after receiving a referral from the subject user.

19. The computer program product of claim 17, wherein the referral recommendation targeting criteria comprises a threshold affinity of the referral recommendations to the subject user.

20. The computer program product of claim 11, wherein presenting a referral opportunity to each subject user is further based on a bid amount included in the sponsoring request associated with the referral opportunity.
